(19) United States
(12) Patent Application Publication
(10) Pub. No.: US 2026/0088275 A1
(43) Pub. Date: Mar. 26, 2026

(54) BATTERY MANUFACTURING METHOD AND BATTERY

(71) Applicant: Panasonic Intellectual Property Management Co., Ltd., Osaka (JP)

(72) Inventors: Kunihiko MINEYA, Osaka (JP); Tadaaki MATSUMURA, Shiga (JP)

(21) Appl. No.: 19/406,488

(22) Filed: Dec. 2, 2025

Related U.S. Application Data
(63) Continuation of application No. PCT/JP2024/014319, filed on Apr. 8, 2024.

(30) Foreign Application Priority Data
Jun. 7, 2023 (JP) 2023-094093

(51) Int. Cl. H01M 4/04; H01M 4/02; H01M 4/485; H01M 10/0525; H01M 10/0585

(52) U.S. Cl. CPC H01M 4/0447; H01M 4/485; H01M 10/0585; H01M 2004/021; H01M 2004/027; H01M 10/0525

(57) ABSTRACT

A battery manufacturing method according to the present disclosure includes: (A) performing charge/discharge processing on a power generation element including a positive electrode layer, a negative electrode layer, and an electrolyte layer located between the positive electrode layer and the negative electrode layer in a state where the power generation element is restrained in a stacking direction; and (B) decreasing a restraining pressure on the power generation element after the charge/discharge processing in the (A). At least one electrode layer selected from the group consisting of the positive electrode layer and the negative electrode layer includes an electrode active material having a coefficient of volumetric expansion in a charged state relative to a discharged state of 2% or more and 14% or less.

This application is a continuation of PCT/JP2024/014319 filed on Apr. 8, 2024, which claims foreign priority of Japanese Patent Application No. 2023-094093 filed on Jun. 7, 2023, the entire contents of both of which are incorporated herein by reference.

### BACKGROUND OF THE INVENTION

### 1. Field of the Invention

The present disclosure relates to a battery manufacturing method and a battery.

### 2. Description of Related Art

In association with rapid spreading of, for example, information-related devices and communication devices such as personal computers, video cameras, and mobile phones in recent years, development of batteries to be used as power supplies for these devices has been considered important. Also, development of high-power and high-capacity batteries has been progressing for battery electric vehicles or hybrid electric vehicles in the automobile industry. In particular, development of lithium batteries having high energy densities has been progressing.

As electrode active materials for batteries such as ones described above, materials having high theoretical capacities are expected to be used. For example, in the case of a negative electrode, a material that has a high theoretical capacity and that, in particular, has a high negative electrode potential at the last stage of charging with the probability of lithium deposition being low during charging is expected to be used as a negative electrode active material.

Meanwhile, no use of combustible organic electrolytic solution in a battery leads to simplification of a safety device and leads to excellence in terms of production cost and productivity. From such a viewpoint, development of all-solid batteries each obtained by substituting an organic electrolytic solution with a solid electrolyte layer to bring the battery into an all-solid state has also been progressing.

Regarding negative electrode active materials of the all-solid batteries as well, materials that allow obtainment of higher battery capacities are expected as the electrode active materials in the same manner as in liquid-based batteries that use organic electrolytic solutions or the like and that have been conventionally developed and put into practical use. For example, in the case of a negative electrode, a material that allows obtainment of a higher battery capacity and that has a high negative electrode potential at the last stage of charging with the probability of lithium deposition being low during charging is expected to be used as a negative electrode active material. For example, oxide-based materials in addition to carbon-based materials are expected to be used as the negative electrode active materials of the all-solid batteries. However, many of the materials newly expected as electrode active materials expand and contract during charging/discharging. Such expansion and contraction of an electrode active material during charging/discharging lead to generation of a crack in a solid electrolyte included in the electrode and lead to decrease in the performance of the battery.

There are batteries that can solve the above problem arising from expansion and contraction of an electrode active material during charging/discharging. As one of such batteries, for example, JP 2022-110345A particularly discloses a battery including a restraining member for restraining, in a stacking direction, a power generation element having a positive electrode, a negative electrode, and a solid electrolyte in order to solve the problem arising from expansion and contraction of a positive electrode active material.

An object of the present disclosure is to, in a battery using an electrode active material expandable and contractible during charging/discharging, suppress generation of a crack in an electrode in association with charging/discharging so as to suppress a decrease in discharge capacity through a method simpler than conventional methods.

### SUMMARY OF THE INVENTION

A battery manufacturing method according to the present disclosure includes:
(A) performing charge/discharge processing on a power generation element including a positive electrode layer, a negative electrode layer, and an electrolyte layer located between the positive electrode layer and the negative electrode layer in a state where the power generation element is restrained in a stacking direction; and
(B) decreasing a restraining pressure on the power generation element after the charge/discharge processing in the (A), wherein
at least one electrode layer selected from the group consisting of the positive electrode layer and the negative electrode layer includes an electrode active material having a coefficient of volumetric expansion in association with charging/discharging of 2% or more and 14% or less.

The manufacturing method according to the present disclosure enables, in a battery using an electrode active material expandable and contractible during charging/discharging, suppression of generation of a crack in an electrode in association with charging/discharging so as to suppress a decrease in discharge capacity through a method simpler than conventional methods.

### BRIEF DESCRIPTION OF THE DRAWINGS

FIG. 1 is a flowchart showing a battery manufacturing method according to embodiment 1.

FIG. 2 is a cross-sectional view showing an example of a power generation element to be used for the battery manufacturing method according to embodiment 1.

FIG. 3 is a schematic diagram showing an example of a situation in which the power generation element shown in FIG. 2 is restrained in a stacking direction.

FIG. 4 is a cross-sectional view showing an example of a battery according to embodiment 2.

FIG. 5 is a schematic diagram showing a cross section along a thickness direction of a negative electrode layer in the battery according to embodiment 2.

### DETAILED DESCRIPTION

### (Findings as Basis for Present Disclosure)

The battery disclosed in JP 2022-110345A described in the section [2. Description of Related Art] is required to include, in a completed battery state, a restraining member for restraining a power generation element having a positive electrode, a negative electrode, and a solid electrolyte in a stacking direction in order to suppress generation of a crack in association with expansion and contraction of an electrode active material (in particular, a positive electrode active material) during charging/discharging.

Electrode active materials selectable in order to achieve a high capacity also include an electrode active material expandable and contractible to a large extent during charging/discharging. As a result of conducting thorough studies, the present inventors obtained a finding that, in an electrode including such an electrode active material expandable and contractible to a large extent, a crack generated between the electrode active material and a solid electrolyte in addition to a crack generated between solid electrolytes might become a principal factor of decreasing a discharge capacity.

In view of the above circumstance, the present inventors further advanced thorough studies on technologies enabling, in a battery using such an electrode active material expandable and contractible during charging/discharging, effective suppression of generation of a crack between the electrode active material and a solid electrolyte after charging/discharging so as to suppress a decrease in discharge capacity through a method simpler than conventional methods. As a result, the present inventors have conceived of a battery manufacturing method and a battery according to the present disclosure described below.

Hereinafter, embodiments of the present disclosure will be described with reference to the drawings.

### Embodiment 1

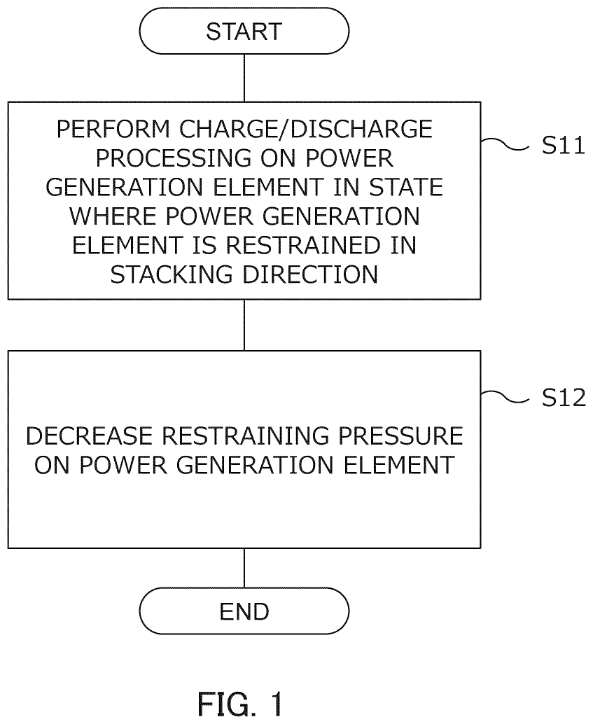

FIG. 1 is a flowchart showing a battery manufacturing method according to embodiment 1.

As shown in FIG. 1, the battery manufacturing method according to embodiment 1 includes:
(A) performing charge/discharge processing on a power generation element including a positive electrode layer, a negative electrode layer, and an electrolyte layer located between the positive electrode layer and the negative electrode layer in a state where the power generation element is restrained in a stacking direction (S11); and
(B) decreasing a restraining pressure on the power generation element after the charge/discharge processing in the (A) (S12).

At least one electrode layer selected from the group consisting of the positive electrode layer and the negative electrode layer includes an electrode active material having a coefficient of volumetric expansion in association with charging/discharging of 2% or more and 14% or less.

In the manufacturing method according to embodiment 1, charge/discharge processing is performed in a state where the power generation element in which the positive electrode layer, the electrolyte layer, and the negative electrode layer are disposed in this order is restrained in the stacking direction, and then the restraining pressure on the power generation element is decreased to complete a battery. The “stacking direction” in the present disclosure means the direction in which the positive electrode layer, the electrolyte layer, and the negative electrode layer are stacked. The manufacturing method according to embodiment 1 eliminates the need for continuously restraining a completed battery as in conventional technologies. Consequently, the manufacturing method enables effective suppression of generation of a crack between the electrode active material and a solid electrolyte after charging/discharging so as to suppress a decrease in discharge capacity through a method simpler than methods for conventional batteries.

Here, the “coefficient of volumetric expansion in association with charging/discharging” of the electrode active material in the battery according to embodiment 1 refers to a coefficient of volumetric expansion between a charged state and a discharged state of the electrode active material. In one example, in a case where the electrode active material is a negative electrode active material, the coefficient of volumetric expansion between a charged state and a discharged state is a coefficient of expansion of the volume in the charged state relative to the volume in the discharged state. In another example, in a case where the electrode active material is a positive electrode active material, the coefficient of volumetric expansion between a charged state and a discharged state is a coefficient of expansion of the volume in the discharged state relative to the volume in the charged state. Hereinafter, the positive electrode layer and/or the negative electrode layer including the electrode active material having a coefficient of volumetric expansion in association with charging/discharging of 2% or more and 14% or less, is written as “electrode layer” in the present description.

In the present disclosure, the coefficient of volumetric expansion in association with charging/discharging of the electrode active material is a theoretical value. Specifically, the theoretical value of the coefficient of volumetric expansion is, regarding the crystal structure of each material that is used as the electrode active material, obtained by using: the volume of a unit cell in a completely lithiated state, i.e., a state where lithium ions are occluded (e.g., corresponding to a fully-charged state in the case of a negative electrode active material); and the volume of the unit cell in a completely delithiated state, i.e., a state where lithium ions are released (e.g., corresponding to a fully-discharged state in the case of a negative electrode active material). For example, the document “J. Deng et al., “Selective Doping to Controllably Tailor Maximum Unit-Cell-Volume Change of Intercalating Li⁺-Storage Materials: A Case Study of γ Phase Li₃VO₄”, Advanced Science, 2022, 9, 2106003” shows, in FIG. 1j, theoretical values of the coefficients of volumetric expansion between a charged state and a discharged state in relation to exemplary electrode active materials.

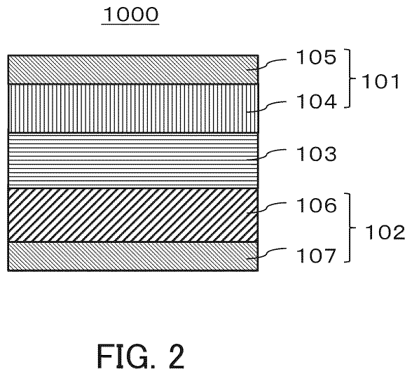

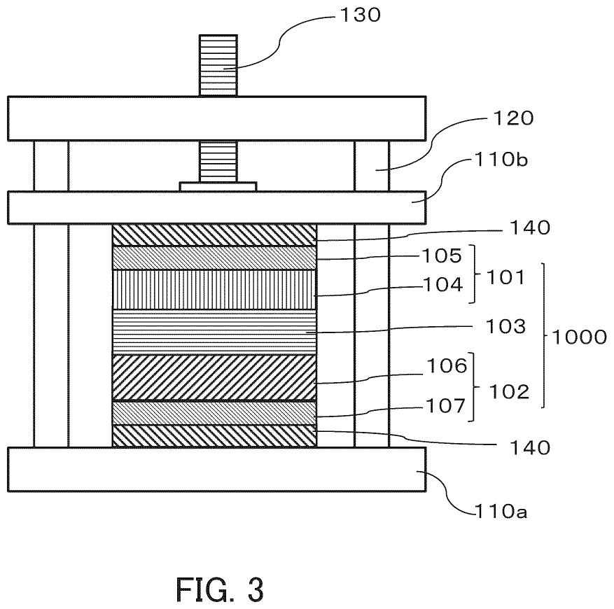

FIG. 2 is a cross-sectional view showing an example of the power generation element to be used for the battery manufacturing method according to embodiment 1. FIG. 3 is a schematic diagram showing an example of a situation in which the power generation element shown in FIG. 2 is restrained in the stacking direction.

As shown in FIG. 2, a power generation element 1000 includes a positive electrode layer 101, a negative electrode layer 102, and an electrolyte layer 103. The electrolyte layer 103 is disposed between the positive electrode layer 101 and the negative electrode layer 102. The electrolyte layer 103 is, for example, a solid electrolyte layer. The power generation element 1000 to be used for the manufacturing method according to embodiment 1 forms, for example, an all-solid battery.

The positive electrode layer 101 includes, for example, a positive electrode active material layer 104 and a positive electrode current collector 105. The positive electrode layer 101 is disposed in such an orientation that the positive electrode active material layer 104 faces the electrolyte layer 103. The negative electrode layer 102 includes, for example, a negative electrode active material layer 106 and a negative electrode current collector 107. The negative electrode layer 102 is disposed in such an orientation that the negative electrode active material layer 106 faces the electrolyte layer 103.

In the manufacturing method according to embodiment 1, the charge/discharge processing for the power generation element 1000 in the above (A) is performed in a state where the power generation element 1000 is restrained in the stacking direction. A member (restraining member) to be used for restraining the power generation element 1000 is not particularly limited as long as the member can apply a restraining pressure in the stacking direction to the power generation element 1000. For example, a publicly-known restraining member usable as a restraining member for an all-solid battery may be used. As shown in FIG. 3, one example of the restraining member has: a lower-side pressure application plate 110a as a plate-shaped portion for applying a pressure to a lower surface of the power generation element 1000; an upper-side pressure application plate 110b as a plate-shaped portion for applying a pressure to an upper surface of the power generation element 1000; rod-shaped portions 120 coupling the lower-side pressure application plate 110a and the upper-side pressure application plate 110b; and an adjustment portion 130 which is coupled to the rod-shaped portions 120 and which is for adjusting, by a screw structure or the like, the restraining pressure to be applied to the power generation element 1000. In the example shown in FIG. 3, the adjustment portion 130 adjusts the position of the upper-side pressure application plate 110b relative to the lower-side pressure application plate 110a, thereby being able to apply a desired restraining pressure to the power generation element 1000. The power generation element 1000 in a restrained state may be, for example, sealed in an exterior member. In this case, as shown in FIG. 3, an exterior member 140 is present between the power generation element 1000 and each of the lower-side pressure application plate 110a and the upper-side pressure application plate 110b.

The above (A) may include restraining the power generation element 1000 at, for example, a restraining pressure of 1 MPa or more. Performing the charge/discharge processing in a state where the power generation element 1000 is restrained at such a restraining pressure enables, even when a completed battery is subjected to charging/discharging in a non-restrained state, effective suppression of generation of a crack between the negative electrode active material and a solid electrolyte after the charging/discharging so as to further suppress a decrease in discharge capacity. The restraining pressure may be 5 MPa or more in order to more effectively suppress generation of a crack in the negative electrode layer in association with charging/discharging so as to further suppress a decrease in discharge capacity. Increase in the restraining pressure leads to an advantage of easily obtaining favorable contact with each of the layers. Meanwhile, the restraining pressure may be, for example, 100 MPa or less, 50 MPa or less, 20 MPa or less, or 14 MPa or less. The reason is that, when the restraining pressure is excessively high, the restraining member is required to have a high rigidity, and there is a possibility that the restraining member is upsized.

The charge/discharge processing in the above (A) is not particularly limited as long as an intended design capacity can be achieved. For example, constant current charging (CC charging) may be performed within a range of 2C to 1/20C for a positive electrode capacity. Alternatively, for example, CCCV charging may be performed in which: the CC charging is performed within the range of 2C to 1/20C for the positive electrode capacity; and constant voltage charging (CV charging) is subsequently performed when the battery voltage reaches a specified value.

The above (B) includes decreasing the restraining pressure on the power generation element 1000 after the charge/discharge processing in the above (A). In the above (B), the restraining pressure on the power generation element 1000 may be decreased by, for example, 90% or more, 95% or more, or 98% or more. In the above (B), the power generation element 1000 may be released from the restraint. That is, the restraining pressure on the power generation element 1000 may be decreased by 100%.

Hereinafter, the power generation element to be used for the manufacturing method according to embodiment 1 will be described in detail. Hereinafter, the “power generation element to be used for the manufacturing method according to embodiment 1” is written as “power generation element according to embodiment 1”.

### [Power Generation Element]

The power generation element 1000 according to embodiment 1 includes the positive electrode layer 101, the negative electrode layer 102, and the electrolyte layer 103. The electrolyte layer 103 is disposed between the positive electrode layer 101 and the negative electrode layer 102. The electrolyte layer 103 is, for example, a solid electrolyte layer. The power generation element 1000 according to embodiment 1 may constitute an all-solid battery.

### [Positive Electrode Layer]

The positive electrode layer 101 includes, for example, the positive electrode active material layer 104 and the positive electrode current collector 105.

### [Positive Electrode Active Material Layer]

The positive electrode active material layer 104 includes a positive electrode active material. The positive electrode active material layer 104 may include, as optional components, a solid electrolyte, an electrically conductive material, a binder, and the like.

As the positive electrode active material, a positive electrode active material having a characteristic of occluding and releasing metal ions (e.g., lithium ions) may be used. The positive electrode active material included in the positive electrode active material layer 104 has, for example, a coefficient of volumetric expansion in association with charging/discharging, i.e., a coefficient of volumetric expansion in a discharged state relative to a charged state, of 2% or more and 14% or less.

As the positive electrode active material, for example, a lithium-containing transition metal oxide, a transition metal fluoride, a polyanion material, a fluorinated polyanion material, a transition metal sulfide, a transition metal oxysulfide, a transition metal oxynitride, or the like may be used. In particular, in a case where a lithium-containing transition metal oxide is used as the positive electrode active material, production cost can be made low, and an average discharge voltage can be made high. Examples of the lithium-containing transition metal oxide include Li(NiCoAl)O₂, Li(NiCoMn)O₂, and LiCoO₂.

The form of the positive electrode active material is not particularly limited and may be a particulate form. In a case where the positive electrode active material is in a particulate form, the positive electrode active material may be primary particles or secondary particles.

A coat layer containing a Li-ion-conductive oxide may be formed on a surface of the positive electrode active material. The reason is that such a coat layer can suppress a reaction between the positive electrode active material and the solid electrolyte.

Examples of the Li-ion-conductive oxide include LiNbO₃, Li₄T₁₅O₁₂, and Li₃PO₄. The thickness of the coat layer is, for example, 0.1 nm or more and may be 1 nm or more. Meanwhile, the thickness of the coat layer is, for example, 100 nm or less and may be 20 nm or less. The coat layer may, for example, coat 70% or more of the surface of the positive electrode active material or coat 90% or more of the surface of the positive electrode active material.

Examples of the solid electrolyte can include the same solid electrolytes as those presented as examples in relation to the electrolyte layer 103.

The solid electrolyte content of the positive electrode active material layer 104 is not particularly limited and may be, for example, within a range of 1% by mass or more and 80% by mass or less with the total mass of the positive electrode active material layer being taken as 100% by mass.

As the electrically conductive material, a publicly-known electrically conductive material may be used, and examples thereof include carbon materials and metal particles.

Examples of the carbon materials can include at least one type of carbon material selected from the group consisting of acetylene black, furnace black, vapor-grown carbon fiber (VGCF), carbon nanotube, and carbon nanofiber. Among these carbon materials, at least one type of carbon material selected from the group consisting of VGCF, carbon nanotube, and carbon nanofiber may be used from the viewpoint of electron conductivity. Examples of the metal particles include particles of Ni, Cu, Fe, and SUS.

The electrically conductive material content of the positive electrode active material layer 104 is not particularly limited.

Examples of the binding agent (binder) can include acrylonitrile-butadiene rubber (ABR), butadiene rubber (BR), polyvinylidene fluoride (PVdF), and styrene-butadiene rubber (SBR). The binder content of the positive electrode layer is not particularly limited.

The thickness of the positive electrode active material layer 104 is not particularly limited and may be, for example, 10 μm or more and 100 μm or less, or 10 μm or more and 20 μm or less.

The positive electrode active material layer 104 can be formed through a publicly-known method.

For example, the positive electrode active material layer 104 is obtained by: supplying the positive electrode active material and, as necessary, other components into a solvent; stirring the mixture to produce a slurry for a positive electrode active material layer; applying the slurry for a positive electrode active material layer onto one surface of a support member; and drying the slurry.

Examples of the solvent include butyl acetate, butyl butyrate, mesitylene, tetralin, heptane, and N-methyl-2-pyrrolidone (NMP).

The method for applying the slurry for a positive electrode active material layer onto one surface of the support member is not particularly limited, and examples of the method include a doctor blade method, a metal mask printing method, an electrostatic coating method, a dip coating method, a spray coating method, a roll coating method, a gravure coating method, and a screen printing method.

As the support member, a self-supporting member may be selected and used as appropriate. Such a support member is not particularly limited, and, for example, metal foil of Cu, Al, or the like may be used.

Another method for forming the positive electrode active material layer 104 may include compacting a powder of a positive electrode mixture containing the positive electrode active material and, as necessary, other components, thereby forming the positive electrode active material layer 104. In the case of compacting the powder of the positive electrode mixture, a pressure of about 1 MPa or more and 2000 MPa or less is usually applied.

The method for applying the pressure is not particularly limited, and examples of the method include a method in which a flat plate press, a roll press, or the like is used to apply the pressure.

### [Positive Electrode Current Collector]

As the positive electrode current collector 105, for example, a publicly-known metal usable as a current collector for an all-solid battery may be used. Examples of such a metal can include metal materials containing at least one element selected from the group consisting of Cu, Ni, Al, V, Au, Pt, Mg, Fe, Ti, Co, Cr, Zn, Ge, and In. Examples of the positive electrode current collector 105 include SUS, aluminum, nickel, iron, titanium, and carbon.

The form of the positive electrode current collector 105 is not particularly limited and may be in any of various forms such as a foil form and a mesh form. The thickness of the positive electrode current collector 105 varies depending on the shape thereof and may be, for example, within a range of 1 μm or more and 50 μm or less or within a range of 5 μm or more and 20 μm or less.

### [Negative Electrode Layer]

The negative electrode layer 102 includes, for example, the negative electrode active material layer 106 and the negative electrode current collector 107.

### [Negative Electrode Active Material Layer]

The negative electrode active material layer 106 at least includes a negative electrode active material and, as necessary, includes a solid electrolyte, an electrically conductive material, a binding agent, and the like.

The negative electrode active material included in the negative electrode active material layer 106 has, for example, a coefficient of volumetric expansion in association with charging/discharging, i.e., a coefficient of volumetric expansion in a charged state relative to a discharged state, of 2% or more and 14% or less. Examples of such a negative electrode active material include graphite, mesocarbon microbead (MCMB), highly oriented pyrolytic graphite (HOPG), hard carbon, soft carbon, lithium alone, lithium alloys, and oxide-based materials.

Examples of the lithium alloys include Li—Au, Li—Mg, Li—Sn, Li—Si, Li—Al, Li—B, Li—C, Li—Ca, Li—Ga, Li—Ge, Li—As, Li—Se, Li—Ru, Li—Rh, Li—Pd, Li—Ag, Li—Cd, Li—In, Li—Sb, Li—Ir, Li—Pt, Li—Hg, Li—Pb, Li—Bi, Li—Zn, Li—Tl, Li—Te, and Li—At.

Examples of the oxide-based materials include a compound containing Ti, Nb, and O. By using such a compound as the negative electrode active material, a high battery capacity can be obtained.

The compound containing Ti, Nb, and O may be, for example, represented by the following compositional formula (1):

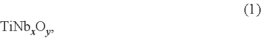

where
x satisfies 1.5≤x≤2.5, and y satisfies 6.5≤y≤7.5.

By using the compound represented by the above compositional formula (1) as the negative electrode active material, a higher battery capacity can be obtained.

The compound represented by the above compositional formula (1) may be, for example, TiNb₂O₇. By using TiNb₂O₇ as the negative electrode active material, an even higher battery capacity can be obtained.

The negative electrode active material layer 106 may include a plurality of types of negative electrode active materials. For example, the negative electrode active material layer 106 may further include, in addition to the negative electrode active material having a coefficient of volumetric expansion in a charged state relative to a discharged state of 2% or more and 14% or less (first negative electrode active material), a negative electrode active material having a coefficient of volumetric expansion in a charged state relative to a discharged state outside of the above range (second negative electrode active material). The proportion of the first negative electrode active material to all of the negative electrode active materials may be, for example, 80% by mass or more. The proportion of the first negative electrode active material to all of the negative electrode active materials may be 100%.

The form of the negative electrode active material is not particularly limited, and examples of the form include a particulate form and a plate form. In a case where the negative electrode active material is in a particulate form, the negative electrode active material may be primary particles or secondary particles.

As the electrically conductive material and the binding agent to be used for the negative electrode active material layer 106, the same electrically conductive materials and binding agents as those presented as examples in relation to the positive electrode active material layer 104 may be used. Examples of the solid electrolyte to be used for the negative electrode active material layer 106 can include the same solid electrolytes as those presented as examples in relation to the electrolyte layer 103.

The thickness of the negative electrode active material layer 106 is not particularly limited and may be, for example, 10 μm or more and 100 μm or less, or 10 μm or more and 20 μm or less.

The negative electrode active material content of the negative electrode active material layer 106 is not particularly limited and may be, for example, 20% by mass or more and 90% by mass or less.

The negative electrode active material layer 106 may be formed such that, for example, the ratio of the charge specific capacity of the negative electrode to the charge specific capacity of the positive electrode is 1.0 time or more and 2.0 times or less or is 1.0 time or more and 1.2 times or less.

### [Negative Electrode Current Collector]

The negative electrode current collector 107 may be made from a material that cannot be made into an alloy together with Li, and examples of the material can include SUS, copper, and nickel. A material that can be made into an alloy together with Li may also be used when the operating potential of the negative electrode active material is within a range that does not allow the material to be made into an alloy together with Li. For example, in the case of using Al as the negative electrode current collector, the Al may be used when the operating potential range of the negative electrode is 0.3 V or more. Examples of the form of the negative electrode current collector 107 can include a foil form and a plate form. The shape of the negative electrode current collector 107 in a plan view is not particularly limited, and examples of the shape can include a circular shape, an elliptical shape, a rectangular shape, and any polygonal shape. The thickness of the negative electrode current collector 107 varies depending on the shape thereof and may be, for example, within a range of 1 μm or more and 50 μm or less or within a range of 5 μm or more and 20 μm or less.

### [Electrolyte Layer]

The electrolyte layer includes a solid electrolyte.

As the solid electrolyte to be included in the electrolyte layer, a publicly-known solid electrolyte usable for an all-solid battery may be used as appropriate. Examples of the solid electrolyte include inorganic solid electrolytes such as a sulfide-based solid electrolyte, an oxide-based solid electrolyte, a hydride-based solid electrolyte, a halide-based solid electrolyte, and a nitride-based solid electrolyte. The sulfide-based solid electrolyte may contain sulfur (S) as a principal component that is an anion element. The oxide-based solid electrolyte may contain oxygen (O) as a principal component that is an anion element. The hydride-based solid electrolyte may contain hydrogen (H) as a principal component that is an anion element. The halide-based solid electrolyte may contain a halogen (X) as a principal component that is an anion element. The nitride-based solid electrolyte may contain nitrogen (N) as a principal component that is an anion element.

The sulfide-based solid electrolyte may be sulfide glass, crystallized sulfide glass (glass ceramic), or a crystalline material obtained by performing solid-phase reaction treatment on a raw material composition.

The crystal state of the sulfide-based solid electrolyte can be ascertained by, for example, performing powder X-ray diffraction measurement using CuKα-rays on the sulfide-based solid electrolyte.

The sulfide glass can be obtained by performing amorphization treatment on a raw material composition (e.g., a mixture of Li₂S and P₂S₅). Examples of the amorphization treatment include mechanical milling.

The glass ceramic can be obtained by, for example, performing heat treatment on the sulfide glass.

The temperature for the heat treatment only has to be a temperature higher than a crystallization temperature (Tc) observed through thermal analysis measurement of the sulfide glass and is usually 195° C. or more. Meanwhile, the upper limit of the temperature for the heat treatment is not particularly limited.

The crystallization temperature (Tc) of the sulfide glass can be measured through differential thermal analysis (DTA).

The time for the heat treatment is not particularly limited as long as the time allows obtainment of a desired degree of crystallinity of the glass ceramic. For example, the time for the heat treatment is within a range of 1 minute or more and 24 hours or less and, in particular, within a range of 1 minute or more and 10 hours or less.

The method for the heat treatment is not particularly limited, and examples of the method can include a method in which a firing furnace is used.

Examples of the oxide-based solid electrolyte include a solid electrolyte containing Li element, Y element (Y represents at least one element selected from the group consisting of Nb, B, Al, Si, P, Ti, Zr, Mo, W, and S), and O element. Specific examples of the oxide-based solid electrolyte include: garnet-type solid electrolytes such as Li₇La₃Zr₂O₁₂, Li₇₋ₓLa₃(Zr₂₋ₓNbₓ)O₁₂ (0≤x≤2), and Li₅La₃Nb₂O₁₂; perovskite-type solid electrolytes such as (Li, La)TiO₃, (Li, La)NbO₃, and (Li, Sr)(Ta, Zr)O₃; NASICON-type solid electrolytes of Li(Al, Ti)(PO₄)₃ and Li(Al, Ga)(PO₄)₃; Li—P—O-based solid electrolytes such as Li₃PO₄ and LIPON (a compound obtained by substituting at least one of “O”s in Li₃PO₄ with N); and Li—B—O-based solid electrolytes such as Li₃BO₃ and a compound obtained by substituting at least one of “O”s in Li₃BO₃ with C.

The hydride-based solid electrolyte has, for example, Li and a complex anion containing hydrogen. Examples of the complex anion include (BH₄)⁻, (NH₂)⁻, (AlH₄)⁻, and (AlH₆)₃⁻.

Examples of the halide-based solid electrolyte include Li_{6-3z}Y_{z}X₆ (X represents at least one type out of Cl and Br, and z satisfies 0<z<2).

Examples of the nitride-based solid electrolyte include Li₃N.

The form of the solid electrolyte may be a particulate form from the viewpoint of favorable handleability.

The average particle diameter of the particles of the solid electrolyte is not particularly limited. The average particle diameter of the particles of the solid electrolyte is, for example, 10 nm or more and may be 100 nm or more. Meanwhile, the average particle diameter is, for example, 25 μm or less and may be 10 μm or less.

In the present disclosure, the average particle diameter of the particles is the value of a median diameter (D50) on a volume basis measured through laser diffraction/scattering particle size distribution measurement unless otherwise noted. In the present disclosure, the median diameter (D50) is a diameter (volume-average diameter) at which the cumulative volume of particles becomes half (50%) the volume of all of particles arranged in ascending order of particle diameter.

One of these types of solid electrolytes may be used singly, or two or more of these types of solid electrolytes may be used. In the case of using two or more of these types of solid electrolytes, the two or more types of solid electrolytes may be mixed, or these solid electrolytes may be formed into two or more respective layers to have a multi-layer structure.

The proportion of the solid electrolyte in the electrolyte layer 103 is not particularly limited. The proportion is, for example, 50% by mass or more, may be within a range of 60% by mass or more and 100% by mass or less, may be within a range of 70% by mass or more and 100% by mass or less, or may be 100% by mass.

The electrolyte layer 103 may further include a binding agent from the viewpoint of, for example, exhibiting plasticity. Examples of such a binding agent can include the materials presented as examples of the binding agent to be used for the positive electrode active material layer 104. However, the binding agent content of the electrolyte layer 103 may be 5% by mass or less from the viewpoint of, for example, preventing excessive aggregation of the solid electrolyte and enabling formation of a solid electrolyte layer having an evenly-dispersed solid electrolyte in order to easily achieve high power.

The thickness of the electrolyte layer 103 is not particularly limited and is usually 0.1 μm or more and 1 mm or less.

Examples of the method for forming the electrolyte layer 103 include: a method including applying a slurry that is for a solid electrolyte layer and that contains the solid electrolyte onto a support member and drying the slurry; and a method including compacting a powder of a solid electrolyte material containing the solid electrolyte. Examples of the support member can include the same support members as those presented as examples in relation to the positive electrode active material layer 104. In the case of compacting the powder of the solid electrolyte material, a pressure of about 1 MPa or more and 2000 MPa or less is usually applied.

The method for applying the pressure is not particularly limited, and examples of the method include the pressure application method presented as an example in relation to formation of the positive electrode active material layer.

A battery manufactured through the manufacturing method according to embodiment 1 includes the power generation element 1000. The power generation element 1000 has been subjected to charge/discharge processing in the above (A), and then the restraining pressure thereon has been decreased in the above (B).

The battery manufactured through the manufacturing method according to embodiment 1 includes, as necessary, an exterior member accommodating the laminate including the positive electrode current collector, the positive electrode active material layer, the solid electrolyte layer, the negative electrode active material layer, and the negative electrode current collector in this order.

The material of the exterior member is not particularly limited as long as the material is stable with respect to the electrolyte used for the battery, and examples of the material include resins such as polypropylene, polyethylene, and acrylic resins. The exterior member may be, for example, a laminate exterior member.

The battery manufactured through the manufacturing method according to embodiment 1 enables suppression of generation of a crack between at least one of the electrode active materials and the corresponding solid electrolyte after charging/discharging. For example, the battery manufactured through the manufacturing method according to embodiment 1 is as follows. In a scanning electron microscope image of a cross section along a thickness direction of at least one of the electrode layers with a layer direction of the electrode layer (i.e., a planar direction of the electrode layer) and the thickness direction of the electrode layer being respectively defined as an x-axis direction and a y-axis direction, an average value Lx (ave) of x-axis projection lengths Lx each obtained by projecting, in the x-axis direction, a line segment length L connecting a start point and an end point of a crack present on the above cross section can be set to, for example, 15% or less of a length in the x-axis direction of the above image. In this manner, the battery manufactured through the manufacturing method according to embodiment 1 can satisfy the condition that the average value Lx (ave) of the x-axis projection lengths Lx is 15% or less of the length in the x-axis direction of the above image even after charging/discharging. That is, in the battery manufactured through the manufacturing method according to embodiment 1, the continuity of the electrode active material and the solid electrolyte in the thickness direction of the electrode layer can be maintained to be high even after charging/discharging. Therefore, the battery manufactured through the manufacturing method according to embodiment 1 enables suppression of decrease of the discharge capacity in association with charging/discharging and realization of a high discharge capacity. The electrode layer having such a configuration may be, for example, the negative electrode layer.

The battery manufactured through the manufacturing method according to embodiment 1 may be a battery having only one such power generation element 1000 or may be a battery having a plurality of the power generation elements 1000 stacked on each other.

The battery manufactured through the manufacturing method according to embodiment 1 is, for example, an all-solid battery and may be an all-solid lithium secondary battery, an all-solid lithium-ion secondary battery, or the like.

Examples of the shape of the battery manufactured through the manufacturing method according to embodiment 1 can include a coin shape, a laminate shape, a cylindrical shape, and a prismatic shape.

Use of the battery manufactured through the manufacturing method according to embodiment 1 is not particularly limited, and examples of the use include a power supply for a vehicle such as a hybrid electric vehicle (HEV), a plug-in hybrid electric vehicle (PHEV), a battery electric vehicle (BEV), a gasoline automobile, or a diesel automobile. In particular, the battery may be used as a power supply for driving a hybrid electric vehicle, a plug-in hybrid electric vehicle, or a battery electric vehicle. Alternatively, the battery manufactured through the manufacturing method according to embodiment 1 may be used as a power supply for a moving body (e.g., a train, a ship, or aircraft) other than such vehicles or may be used as a power supply for an electric product such as an information processor.

### Embodiment 2

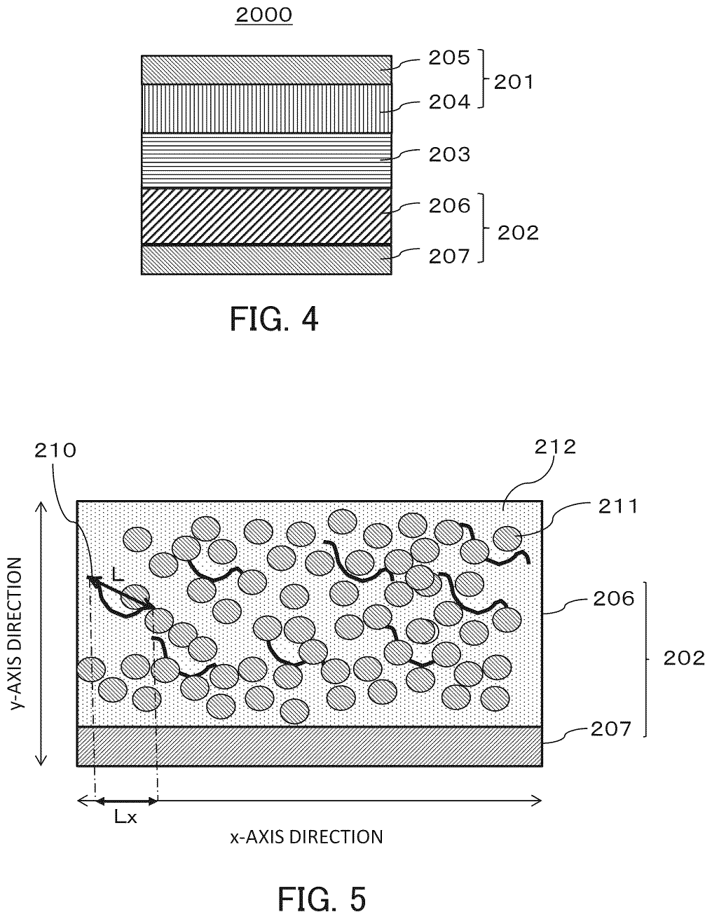

FIG. 4 is a cross-sectional view showing an example of a battery according to embodiment 2. FIG. 5 is a schematic diagram showing a cross section along a thickness direction of a negative electrode layer in the battery according to embodiment 2.

As shown in FIG. 4, a battery 2000 according to embodiment 2 includes a positive electrode layer 201, a negative electrode layer 202, and an electrolyte layer 203 located between the positive electrode layer 201 and the negative electrode layer 202. The positive electrode layer 201 includes, for example, a positive electrode active material layer 204 and a positive electrode current collector 205. The negative electrode layer 202 includes, for example, a negative electrode active material layer 206 and a negative electrode current collector 207.

The battery 2000 according to embodiment 2 is as follows. In a scanning electron microscope image of a cross section along a thickness direction of at least one electrode layer selected from the group consisting of the positive electrode layer 201 and the negative electrode layer 202 with a layer direction of the above electrode layer and the thickness direction of the above electrode layer being respectively defined as an x-axis direction and a y-axis direction, an average value Lx (ave) of x-axis projection lengths Lx each obtained by projecting, in the x-axis direction, a line segment length L connecting a start point and an end point of a crack present on the above cross section is 15% or less of a length in the x-axis direction of the above image. Hereinafter, the battery 2000 according to embodiment 2 will be specifically described by taking, as an example, a case where the above electrode layer is the negative electrode layer 202.

As shown in FIG. 5, the battery 2000 according to embodiment 2 is as follows. In a scanning electron microscope image of a cross section along the thickness direction of the negative electrode layer 202 with the layer direction of the negative electrode layer 202 and the thickness direction of the negative electrode layer 202 being respectively defined as an x-axis direction and a y-axis direction, an average value Lx (ave) of x-axis projection lengths Lx each obtained by projecting, in the x-axis direction, a line segment length L connecting a start point and an end point of a crack 210 present on the above cross section is 15% or less of a length in the x-axis direction of the above image.

The battery 2000 according to embodiment 2 can satisfy the condition that the average value Lx (ave) of the x-axis projection lengths Lx is 15% or less of the length in the x-axis direction of the above image. In the battery 2000 according to embodiment 2, the continuity between a negative electrode active material 211 and a solid electrolyte 212 in the thickness direction (y-axis direction) of the negative electrode layer 202 can be maintained to be high even after charging/discharging. Therefore, in the battery 2000 according to embodiment 2, the interface between the negative electrode active material 211 and the solid electrolyte 212 can be maintained and transference of Li is not hindered even when charging/discharging is performed. Therefore, the battery 2000 according to embodiment 2 enables suppression of decrease of the discharge capacity and realization of a high discharge capacity.

The above image can be acquired by, for example, exposing a cross section along the thickness direction of the battery 2000 through ion milling or the like and imaging the negative electrode layer 202 on the exposed cross section by using a scanning electron microscope. As the image, for example, an image at a magnification of 5000 times is used. Each crack 210 in the negative electrode layer 202 visually recognized within the taken image is, for example, traced with a polyline tool of ImageJ to obtain a polyline of the crack 210. An x-axis projection length Lx is obtained by projecting, in the x-axis direction as the layer direction of the negative electrode layer 202, a line segment length L connecting a start point and an end point of the polyline of the crack 210. Specifically, for example, the angle formed by the x-axis and the line segment L connecting the start point and the end point of the polyline of the crack 210 is defined as 8, and the x-axis projection length Lx can be calculated according to the following mathematical expression (a) by using the angle θ and the line segment length L connecting the start point and the end point of the polyline of the crack.

$$L x = L \times cos θ \qquad ( a )$$

Furthermore, top 10 x-axis projection lengths Lx are selected in descending order within the same field of view, and the average of the 10 x-axis projection lengths Lx is defined as an average value Lx (ave) within this field of view. The proportion of the obtained average value Lx (ave) to the length in the x-axis direction of the image is calculated by percentage.

In the battery 2000 according to embodiment 2, the average value Lx (ave) may be 3.84 μm or less. This configuration enables suppression of generation of a crack in the negative electrode in association with charging/discharging so as to suppress a decrease in discharge capacity.

The battery 2000 according to embodiment 2 can be manufactured through the battery manufacturing method according to embodiment 1. In the battery 2000 according to embodiment 2, the positive electrode layer 201, the negative electrode layer 202, the electrolyte layer 203, the positive electrode active material layer 204, the positive electrode current collector 205, the negative electrode active material layer 206, and the negative electrode current collector 207 respectively correspond to the positive electrode layer 101, the negative electrode layer 102, the electrolyte layer 103, the positive electrode active material layer 104, the positive electrode current collector 105, the negative electrode active material layer 106, and the negative electrode current collector 107 described in embodiment 1. Therefore, detailed description of the above constituents will be omitted in embodiment 2.

### OTHER EMBODIMENTS

### (Additional Notes)

The following technologies are disclosed based on the description of the above embodiments.

### (Technology 1)

A battery manufacturing method including:
(A) performing charge/discharge processing on a power generation element including a positive electrode layer, a negative electrode layer, and an electrolyte layer located between the positive electrode layer and the negative electrode layer in a state where the power generation element is restrained in a stacking direction; and
(B) decreasing a restraining pressure on the power generation element after the charge/discharge processing in the (A), wherein
at least one electrode layer selected from the group consisting of the positive electrode layer and the negative electrode layer includes an electrode active material having a coefficient of volumetric expansion in association with charging/discharging of 2% or more and 14% or less.

The above manufacturing method eliminates the need for continuously restraining a completed battery as in conventional technologies. Consequently, the manufacturing method enables effective suppression of generation of a crack between the electrode active material and the solid electrolyte after charging/discharging so as to suppress a decrease in discharge capacity through a method simpler than methods for conventional batteries.

### (Technology 2)

The battery manufacturing method according to technology 1, wherein the (A) includes restraining the power generation element at a restraining pressure of 1 MPa or more.

The above manufacturing method enables, even when a completed battery is subjected to charging/discharging in a non-restrained state, effective suppression of generation of a crack between the electrode active material and the solid electrolyte after the charging/discharging so as to further suppress a decrease in discharge capacity.

### (Technology 3)

The battery manufacturing method according to technology 1 or 2, wherein the negative electrode layer includes a negative electrode active material having a coefficient of volumetric expansion in association with charging/discharging of 2% or more and 14% or less.

The above manufacturing method enables effective suppression of generation of a crack between the negative electrode active material and the solid electrolyte after charging/discharging so as to suppress a decrease in discharge capacity through a method simpler than methods for conventional batteries.

### (Technology 4)

The battery manufacturing method according to technology 3, wherein the negative electrode active material includes a compound containing Ti, Nb, and O.

The above manufacturing method enables obtainment of a high battery capacity.

### (Technology 5)

The battery manufacturing method according to technology 4, wherein the compound is represented by the following compositional formula (1):

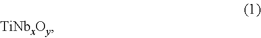

the x satisfies 1.5≤x≤2.5, and
the y satisfies 6.5≤y≤7.5.

The above manufacturing method enables obtainment of a high battery capacity.

### (Technology 6)

The battery manufacturing method according to technology 5, wherein the compound contains TiNb₂O₇.

The above manufacturing method enables obtainment of an even higher battery capacity.

### (Technology 7)

The battery manufacturing method according to any one of technologies 1 to 6, wherein, in a scanning electron microscope image of a cross section along a thickness direction of the electrode layer with a layer direction of the electrode layer and the thickness direction of the electrode layer being respectively defined as an x-axis direction and a y-axis direction, an average value Lx (ave) of x-axis projection lengths Lx each obtained by projecting, in the x-axis direction, a line segment length L connecting a start point and an end point of a crack present on the cross section is 15% or less of a length in the x-axis direction of the image.

The battery manufactured through the above manufacturing method enables suppression of decrease of the discharge capacity in association with charging/discharging and realization of a high discharge capacity.

### (Technology 8)

The battery manufacturing method according to technology 7, wherein the electrode layer is the negative electrode layer.

The battery manufactured through the above manufacturing method enables suppression of decrease of the discharge capacity in association with charging/discharging and realization of a high discharge capacity.

### (Technology 9)

A battery including:
a positive electrode layer;
a negative electrode layer; and
an electrolyte layer located between the positive electrode layer and the negative electrode layer, wherein,
in a scanning electron microscope image of a cross section along a thickness direction of at least one electrode layer selected from the group consisting of the positive electrode layer and the negative electrode layer with a layer direction of the electrode layer and the thickness direction of the electrode layer being respectively defined as an x-axis direction and a y-axis direction, an average value Lx (ave) of x-axis projection lengths Lx each obtained by projecting, in the x-axis direction, a line segment length L connecting a start point and an end point of a crack present on the cross section is 15% or less of a length in the x-axis direction of the image.

The above configuration enables suppression of generation of a crack in the electrode in association with charging/discharging so as to suppress a decrease in discharge capacity.

### (Technology 10)

The battery according to technology 9, wherein the electrode layer is the negative electrode layer.

The above configuration enables suppression of generation of a crack in the negative electrode in association with charging/discharging so as to suppress a decrease in discharge capacity.

### (Technology 11)

The battery according to technology 9 or 10, wherein the average value Lx (ave) is 3.84 μm or less.

The above configuration enables suppression of generation of a crack in the negative electrode in association with charging/discharging so as to suppress a decrease in discharge capacity.

### EXAMPLES

### [Production of Sulfide Solid Electrolyte]

In a glove box with an Ar atmosphere at a dewpoint of −60° C. or less, Li₂S and P₂S₅ were weighed out such that Li₂S:P₂S₅=75:25 was satisfied in terms of molar ratio. The Li₂S and the P₂S₅ were pulverized and mixed by using a mortar. Thereafter, a planetary ball mill (model P-7 manufactured by Fritsch GmbH) was used to perform milling treatment for 10 hours at 510 rpm. Consequently, a glassy solid electrolyte was obtained. The glassy solid electrolyte was subjected to heat treatment for two hours at 270° C. in an inert atmosphere. Consequently, Li₂S—P₂S₅ as a solid electrolyte in the form of glass ceramic was obtained.

### [Production of Paste for Positive Electrode Active Material Layer]

LiNi_{0.8}Co_{0.15}Al_{0.05}O₂ (density: 4.65 g/cc, average particle diameter: 5 μm) was used as a positive electrode active material. The positive electrode active material was subjected to surface treatment with LiNbO₃ by a rolling fluidized bed granulation coating device. 4.0 g of this positive electrode active material subjected to the surface treatment, 0.094 g of VGCF as an electrically conductive material, 1.024 g of the sulfide solid electrolyte Li₂S—P₂S₅ produced through the above method, 0.017 g of a butadiene rubber-based binder, and 2.77 g of tetralin were weighed out and mixed by using an ultrasonic homogenizer (UH-50 manufactured by SMT Co., Ltd.). The resultant mixture was used as a paste for a positive electrode active material layer.

[Production of TiNb₂O₇]

30 g of niobium oxide (Nb₂O₅) powder and 18 g of titanium oxide (TiO₂) powder were premixed by using a planetary mixer. Thereafter, while ethanol was being added as an aid into the obtained mixture, a pod (made of zirconia and having a volume of 45 mL) of the planetary ball mill (P-7 manufactured by Fritsch GmbH) was filled with the mixture. 45 g of zirconia-made balls (diameter: 5 mm) were put into this pod, the pod was closed with a lid, and pulverizing-and-mixing treatment was performed for 50 hours at 400 rpm.

The obtained pulverized mixture was put into an alumina tray, and firing treatment (treatment temperature: 1100° C., treatment time: five hours) was performed in an electric furnace.

The obtained fired product was coarsely pulverized with a power mill until the fired product passed through a 1-mm mesh. Thereafter, the pod (made of zirconia and having a volume of 45 mL) of the planetary ball mill (P-7 manufactured by Fritsch GmbH) was filled with 30 g of the coarsely pulverized powder with water being added thereto. 45 g of zirconia-made balls (diameter: 1 mm) were put into this pod, the pod was closed with the lid, and wet pulverization treatment was performed for 50 hours at 400 rpm. The wet pulverization was stopped when the median diameter (D50) became 2 μm or less while the particle size of the pulverized slurry was being measured over time with a laser diffraction particle size meter.

The obtained pulverized slurry was dried with a vacuum drying oven, whereby a titanium-niobium composite oxide powder was obtained. A principal component of the obtained titanium-niobium composite oxide powder was TiNb₂O₇. The theoretical value of the coefficient of volumetric expansion in association with charging/discharging of the TiNb₂O₇ was 7.22%.

The result of measurement of the capacity of the obtained TiNb₂O₇ alone as a Li counter electrode was 250 mAh/g at 1.5 V-0.5 V.

### [Production of Paste for Negative Electrode Active Material Layer]

3.0 g of the TiNb₂O₇ particles (density: 3.54 g/cc) produced through the above method as a negative electrode active material, 0.033 g of an electrically conductive material carbon (density: 2 g/cc), 0.039 g of a butadiene rubber-based binder (density: 0.9 g/cc), and 3.71 g of tetralin were weighed out and mixed for 30 minutes by using the ultrasonic homogenizer (UH-50 manufactured by SMT Co., Ltd.). Thereafter, 1.0 g of the sulfide solid electrolyte Li₂S—P₂S₅ produced through the above method was added to the slurry obtained through the mixing, and mixing was performed again for 30 minutes by using the ultrasonic homogenizer (UH-50 manufactured by SMT Co., Ltd.). The obtained mixture was used as a paste for a negative electrode active material layer.

### [Production of Paste for Solid Electrolyte Layer]

A heptane solution containing heptane and 5% by mass of a butadiene rubber-based binder, and the sulfide solid electrolyte Li₂S—P₂S₅ produced through the above method as a solid electrolyte, were added into a polypropylene-made container and mixed for 30 seconds by using the ultrasonic homogenizer (UH-50 manufactured by SMT Co., Ltd.). Next, the container was shaken for three minutes with a shaker, whereby a paste for a solid electrolyte layer was obtained.

### [Production of Positive Electrode Layer and Negative Electrode Layer]

The paste for a positive electrode active material layer was applied onto a positive electrode current collector (Al foil having a thickness of 15 μm) through a blade method by using an applicator. After being applied, the paste was dried for 30 minutes on a hot press at 100° C., whereby a positive electrode layer having a positive electrode active material layer on the surface of the aluminum foil was obtained. Likewise, the paste for a negative electrode active material layer was applied onto a negative electrode current collector (Ni foil having a thickness of 22 μm) and dried, whereby a negative electrode layer having a negative electrode active material layer on the surface of the Ni foil was obtained. In all of Examples and Comparative Examples, the weight per unit area of the negative electrode active material layer was adjusted such that the charge specific capacity of the negative electrode with the charge specific capacity of the positive electrode being taken as 200 mAh/g became 1.1 times.

### [Production of Solid Electrolyte Layer]

### [Application of Paste for Solid Electrolyte Layer (Positive Electrode Layer Side)]

The above positive electrode layer was pressed in advance. For the positive electrode layer having been pressed in advance, the paste for a solid electrolyte layer was applied onto the surface of the positive electrode active material layer by using a die coater and was dried for 30 minutes on a hot plate at 100° C.

Thereafter, roll press was performed at 2 tons/cm², whereby a positive-electrode-side laminate including a solid electrolyte layer on the surface of the positive electrode active material layer of the positive electrode layer was obtained.

### [Application of Paste for Solid Electrolyte Layer (Negative Electrode Layer Side)]

The above negative electrode layer was pressed in advance. For the negative electrode layer having been pressed in advance, the paste for a solid electrolyte layer was applied onto the surface of the negative electrode active material layer by using a die coater and was dried for 30 minutes on a hot plate at 100° C.

Thereafter, roll press was performed at 2 tons/cm², whereby a negative-electrode-side laminate including a solid electrolyte layer on the surface of the negative electrode active material layer of the negative electrode layer was obtained.

[Manufacturing of all-Solid Lithium-Ion Secondary Battery]

The positive-electrode-side laminate and the negative-electrode-side laminate were each punched and were superposed such that the respective solid electrolyte layers were bonded to each other. The superposition was performed in a state where a solid electrolyte layer (paste for a solid electrolyte layer) having yet to be pressed was transferred between the solid electrolyte layer of the positive-electrode-side laminate and the solid electrolyte layer of the negative-electrode-side laminate. Thereafter, pressing was performed at 160° C. and at 2 tons/cm², whereby a power generation element having the positive electrode layer, a solid electrolyte layer, and the negative electrode layer in this order was obtained. The obtained power generation element was sealed in a laminate exterior, whereby an all-solid lithium-ion secondary battery for evaluation was obtained.

### [Charge/Discharge Processing for Power Generation Element in Restrained State]

Charge/discharge processing for the power generation element in a restrained state was performed as follows.

### Example 1

The restraining member described as an example with reference to FIG. 3 was used as a restraining member for restraining the power generation element sealed in a laminate exterior member. That is, the used restraining member had: plate-shaped portions sandwiching both surfaces of the power generation element; rod-shaped portions coupling the two plate-shaped portions; and an adjustment portion which was coupled to the rod-shaped portions and which was for adjusting a restraining pressure by a screw structure or the like. The adjustment portion adjusted the restraining pressure to be applied to the power generation element.

A restraining pressure was applied to the power generation element sealed in the laminate exterior member, under a condition that the restraining pressure, verified in advance using pressure-indicating film (Prescale), was 8 MPa. That is, in Example 1, the power generation element was restrained in the stacking direction at a restraining pressure of 8 MPa.

Next, the battery was disposed in a thermostatic chamber at 25° C.

Constant current charging was performed at a current value corresponding to a 0.05C rate (20-hour rate) with respect to a positive electrode capacity of 200 mAh/g calculated from the proportion of the active material in the positive electrode layer of the power generation element. The charging was ended 20 hours later.

Furthermore, after a halt of 20 minutes, the power generation element was subjected to constant current discharging at the current value corresponding to the 0.05C rate (20-hour rate). The discharging was ended at 1.5 V.

Next, the voltage at the end of the first time of charging after 20 hours of this first time of charging was regarded as an end-point voltage, and constant current charging was performed at the current value corresponding to the 0.05C rate (20-hour rate). The charging was ended at the aforementioned end-point voltage. After a halt of 20 minutes, constant current discharging was performed at the current value corresponding to the 0.05C rate (20-hour rate). The discharging was ended at 1.5 V.

After the above charge/discharge processing was performed, the power generation element was released from the restraint, whereby a battery in Example 1 was completed.

### Example 2

A battery in Example 2 was completed through the same method as in Example 1, except that the restraining pressure in the charge/discharge processing was changed to 1 MPa.

### Comparative Example 1

A battery in Comparative Example 1 was completed through the same method as in Example 1, except that the power generation element was not restrained during the charge/discharge processing, i.e., the restraining pressure was changed to 0 MPa.

### Comparative Example 2

A battery in Comparative Example 2 was completed through the same method as in Example 1, except that: a power generation element was manufactured by using Li₄Ti₅O₁₂ particles (density: 3.5 g/cc) as a negative electrode active material instead of the TiNb₂O₇; and the power generation element was not restrained during the charge/discharge processing, i.e., the restraining pressure was changed to 0 MPa. The result of measurement of the capacity of the used Li₄Ti₅O₁₂ alone as a Li counter electrode was 175 mAh/g at 1.5 V-0.5 V A theoretical value of the coefficient of volumetric expansion in association with charging/discharging of Li₄Ti₅O₁₂ is 0.2%.

[Evaluation of Initial Negative Electrode Weight Energy Density of all-Solid Lithium-Ion Secondary Battery]

The batteries manufactured in Examples 1 and 2 and Comparative Examples 1 and 2 had the same configuration as the configuration of the battery 2000 shown in FIG. 4. Evaluations of initial negative electrode weight energy densities were conducted through the following charging/discharging test by using the batteries in Examples 1 and 2 and Comparative Examples 1 and 2.

The batteries in a non-restrained state were disposed in a thermostatic chamber at 25° C.

Constant current charging was performed at the current values corresponding to the 0.05C rate (20-hour rate) with respect to the theoretical capacities of the batteries. For each of the batteries, the charging was ended at the voltage at which the first time of charging of the battery was ended after 20 hours of this first time of charging.

Next, constant current discharging was performed at the current value corresponding to the 0.05C rate (20-hour rate). The discharging was ended at the voltage of 1.5 V.

A value obtained by dividing the discharge capacity at this time by the amount of the negative electrode active material used for the battery was regarded as an initial negative electrode weight energy density.

[Evaluation of Crack Length in Negative Electrode of all-Solid Lithium-Ion Secondary Battery]

Each of the batteries for which the evaluation of the initial negative electrode weight energy density was finished was disassembled. The laminate exterior member was removed. An ion milling device (ArBlade (R) 5000 manufactured by Hitachi High-Tech Corporation) was used for the battery composed only of the positive electrode layer, the solid electrolyte layer, and the negative electrode layer to expose a cross section in the thickness direction of the battery.

For cracks in the negative electrode layer, a scanning electron microscope (Regulus 8230 manufactured by Hitachi High-Tech Corporation) was used to take an image (at a magnification of 5000 times) of the negative electrode layer of the battery of which the above cross section was exposed, and each crack in the negative electrode layer visually recognized in the taken image was traced with the polyline tool of ImageJ to obtain a polyline of the crack. The layer direction of the negative electrode layer and the thickness direction of the negative electrode layer were respectively defined as an x-axis direction and a y-axis direction. An x-axis projection length Lx was obtained by projecting, in the x-axis direction as the planar direction of the negative electrode layer, a line segment length L connecting a start point and an end point of the polyline of the crack. Specifically, the angle formed by the x-axis and the line segment L connecting the start point and the end point of the polyline of the crack was defined as θ, and the x-axis projection length Lx was calculated according to the following mathematical expression (a) by using the angle θ and the line segment length L connecting the start point and the end point of the polyline of the crack.

$$L x = L \times cos θ \qquad ( a )$$

Furthermore, top 10 x-axis projection lengths Lx were selected in descending order within the same visual field, and the average of the 10 x-axis projection lengths Lx was defined as an average value Lx (ave) within this visual field. The proportion of the obtained average value Lx (ave) to the length (corresponding to 25.6 μm in this case) in the x-axis direction of the image at the magnification of 5000 times was calculated by percentage. This percentage was defined as a crack evaluation measure Lx (%).

The initial negative electrode weight energy densities and the crack evaluation measures Lx (%) of the batteries in Examples 1 and 2 and Comparative Examples 1 and 2 described above are collectively indicated in Table 1.

TABLE 1

| | | | Comparative | Comparative |
|---|---|---|---|---|
| | Example 1 | Example 2 | Example 1 | Example 2 |
| Initial negative | 209 | 209 | 135 | 146 |
| electrode weight | | | | |
| energy density | | | | |
| (mAh/g) | | | | |
| Crack evaluation | 13.6 | 14.4 | 23.2 | 0.16 |
| measure Lx (%) | | | | |

The battery in Example 1 had a larger initial negative electrode weight energy density (mAh/g) than the battery in Comparative Example 1. The reason is considered to be that the battery in Example 1 was subjected to charge/discharge processing in a state where the power generation element was restrained at the time of manufacturing, and thus the interface between the solid electrolyte in the negative electrode layer and the TiNb₂O₇ particles theoretically considered to undergo volume expansion by 7.22% during charging was maintained also in the non-restrained state at the time of the evaluation of the initial negative electrode weight energy density after the battery was completed. The reason is considered to be that the expansion volume of the negative electrode active material during charging was accommodated in the gap inside the electrode owing to the restraint in the stacking direction of the power generation element, i.e., the thickness direction of the electrode, and transference of the interface between the negative electrode active material and the solid electrolyte was suppressed. Furthermore, the battery in Example 1 exhibited a smaller value of crack evaluation measure Lx than the battery in Comparative Example 1. The crack evaluation measure Lx being small indicates that the continuity of the negative electrode active material and the solid electrolyte in the thickness direction of the negative electrode layer was high. Thus, the reason is considered to be that transference of Li was not hindered so that the TiNb₂O₇ particles contributed to charging/discharging.

Similar to the battery in Example 1, the battery in Example 2 also had a larger initial negative electrode weight energy density (mAh/g) than the battery in Comparative Example 1 and had a smaller crack evaluation measure Lx than the battery in Comparative Example 1.

In the battery in Comparative Example 1 with the TiNb₂O₇ being used, the power generation element was not restrained during the charge/discharge processing at the time of manufacturing. Consequently, the battery in Comparative Example 1 had a small initial negative electrode weight energy density (mAh/g) and a large crack evaluation measure Lx. The reason is considered to be that a crack was generated between the TiNb₂O₇ and the solid electrolyte owing to contraction during discharging, Li occluded in the active material during charging was not released from the active material during discharging, and thus the initial negative electrode weight energy density became small. Also, the reason is considered to be that generation of a crack was not suppressed, and thus the crack evaluation measure Lx became large.

In the battery in Comparative Example 2 with Li₄Ti₅O₁₂ particles being used as a negative electrode active material, the active material theoretically undergoes almost no expansion or contraction during charging/discharging, and the theoretical coefficient of volumetric expansion during charging is 0.2%. Therefore, the battery in Comparative Example 2 underwent discharging by a capacity approximately equal to a theoretical value even though restraint was not performed during the charge/discharge processing as in the manufacturing method according to the present disclosure. However, the result of measurement of the capacity of the Li₄Ti₅O₁₂ alone as a Li counter electrode was 175 mAh/g at 1.5 V-0.5 V and was lower than 250 mAh/g which was the capacity of the TiNb₂O₇. Thus, with the same positive electrode being used, the irreversible capacity of the positive electrode was the same (the irreversible capacity of the positive electrode used in this case was 17.6%), and thus the initial negative electrode weight energy density was small. Therefore, since Li₄Ti₅O₁₂ undergoes almost no volume change during charging/discharging, Li₄Ti₅O₁₂ is an excellent negative electrode active material in terms of volume change during charging/discharging, but Li₄Ti₅O₁₂ is not preferable as a negative electrode active material of a battery for which a high capacity is desired. Meanwhile, since Li₄Ti₅O₁₂ theoretically undergoes almost no expansion or contraction during charging/discharging, the crack evaluation measure Lx was very small.

The battery manufacturing method according to the present disclosure can be employed for, for example, nonaqueous lithium-ion batteries or the like in addition to all-solid lithium secondary batteries.

What is claimed is:

1. A battery manufacturing method comprising:
(A) performing charge/discharge processing on a power generation element comprising a positive electrode layer, a negative electrode layer, and an electrolyte layer located between the positive electrode layer and the negative electrode layer in a state where the power generation element is restrained in a stacking direction; and
(B) decreasing a restraining pressure on the power generation element after the charge/discharge processing in the (A), wherein
at least one electrode layer selected from the group consisting of the positive electrode layer and the negative electrode layer comprises an electrode active material having a coefficient of volumetric expansion in association with charging/discharging of 2% or more and 14% or less.

2. The battery manufacturing method according to claim 1, wherein the (A) comprises restraining the power generation element at a restraining pressure of 1 MPa or more.

3. The battery manufacturing method according to claim 1, wherein the negative electrode layer comprises a negative electrode active material having a coefficient of volumetric expansion in association with charging/discharging of 2% or more and 14% or less.

4. The battery manufacturing method according to claim 3, wherein the negative electrode active material comprises a compound comprising Ti, Nb, and O.

5. The battery manufacturing method according to claim 4, wherein the compound is represented by the following compositional formula (1): 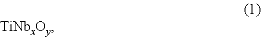
the x satisfies 1.5≤x≤2.5, and
the y satisfies 6.5≤y≤7.5.

6. The battery manufacturing method according to claim 5, wherein the compound comprises TiNb₂O₇.

7. The battery manufacturing method according to claim 1, wherein, in a scanning electron microscope image of a cross section along a thickness direction of the electrode layer with a layer direction of the electrode layer and the thickness direction of the electrode layer being respectively defined as an x-axis direction and a y-axis direction, an average value Lx (ave) of x-axis projection lengths Lx each obtained by projecting, in the x-axis direction, a line segment length L connecting a start point and an end point of a crack present on the cross section is 15% or less of a length in the x-axis direction of the image.

8. The battery manufacturing method according to claim 7, wherein the electrode layer is the negative electrode layer.

9. A battery comprising:
a positive electrode layer;
a negative electrode layer; and
an electrolyte layer located between the positive electrode layer and the negative electrode layer, wherein,
in a scanning electron microscope image of a cross section along a thickness direction of at least one electrode layer selected from the group consisting of the positive electrode layer and the negative electrode layer with a layer direction of the electrode layer and the thickness direction of the electrode layer being respectively defined as an x-axis direction and a y-axis direction, an average value Lx (ave) of x-axis projection lengths Lx each obtained by projecting, in the x-axis direction, a line segment length L connecting a start point and an end point of a crack present on the cross section is 15% or less of a length in the x-axis direction of the image.

10. The battery according to claim 9, wherein the electrode layer is the negative electrode layer.

11. The battery according to claim 9, wherein the average value Lx (ave) is 3.84 μm or less.
